(19) United States
(12) Patent Application Publication
(10) Pub. No.: US 2022/0337638 A1
(43) Pub. Date: Oct. 20, 2022

(54) SYSTEM AND METHOD FOR CREATING COLLABORATIVE VIDEOS (COLLABS) TOGETHER REMOTELY

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 17/723,609

(22) Filed: Apr. 19, 2022

Related U.S. Application Data
(60) Provisional application No. 63/176,892, filed on Apr. 20, 2021.

(51) Int. Cl. H04L 65/402; H04L 65/1089; H04L 65/1093; H04L 65/403; G11B 27/036; G11B 27/034

(52) U.S. Cl. CPC H04L 65/402; H04L 65/1089; H04L 65/1093; H04L 65/403; G11B 27/036; G11B 27/034

(57) ABSTRACT

Exemplary embodiments of the present disclosure are directed towards a system and method for creating collaborative videos (collabs) together remotely, comprising computing devices configured to establish communication with a server over a network; a video creating module configured to enable a first user to create and record one or more video segments, the video creating module configured to enable the first user to insert placeholders on the video segments for second users to record their video segments, the video creating module configured to enable the second users to record the one or more video segments on the video, the server comprises a video collaboration module configured to generate a final video output automatically by combining all the video segments recorded by the second users, the video collaboration module configured to distribute the final video output to the first user and the second users.

### CROSS-REFERENCE TO RELATED APPLICATIONS

This patent application claims priority benefit of U.S. Provisional Patent Application No. 63/176,892, entitled “METHOD AND APPARATUS FOR CREATORS TO CREATE COLLABORATIVE VIDEOS (COLLABS) TOGETHER REMOTELY”, filed on 20 Apr. 2021. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserve all copyright and trademark rights whatsoever.

### TECHNICAL FIELD

The disclosed subject matter relates generally to video collaboration. More particularly, the present disclosure relates to a system and computer-implemented method to create a composite video with parts from multiple creators added in at the right places to create a scripted or unscripted video.

### BACKGROUND

Smart mobile technology has spread rapidly around the globe. Today, it is estimated that every person has a mobile device; as a result, photos and videos are used more and more frequently in ever-increasing number of applications as means for people to convey ideas. Social media sites and applications have grown in popularity. Some existing social media applications and short video platforms have duets, reactions, and stitch as features. Duets and reactions allow a creator to record a side-by-side video with another video to make a composite video. This is limited to one existing video and a new video recording being put together, where the creator may replicate or react to the existing video in their own video recording. However, the video stitching platform allows the creator manually select a portion of an existing video and adds their own video to it. Stitch is also restricted to using one existing video and adding one recording to it. Thus, there is a need to develop a new methodology to create a composite video with parts from multiple creators.

In the light of the aforementioned discussion, there exists a need for a certain system to create a composite video with parts from multiple creators on the computing devices with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and computer implemented method to create a composite video with parts from multiple creators added in at the right places to create a scripted or unscripted video.

Another objective of the present disclosure is directed towards enabling the creators to create the video collaboratively together automatically, without manual editing tools.

Another objective of the present disclosure is directed towards enabling a first user and second users to play multiple roles in the video and collaborate with themselves on the video.

Another objective of the present disclosure is directed towards enabling the first user and the second users to create effortless interviews, conversations, skits, and many such videos that require multiple participants or roles.

Another objective of the present disclosure is directed towards enabling the first user and second users to record their video segments remotely.

Another objective of the present disclosure is directed towards enabling the first users to record the first segment of the video and allow the first users to share it with the second users.

Another objective of the present disclosure is directed towards enabling the first user to insert the placeholders on the video segments for the second users to record their video segments.

Another objective of the present disclosure is directed towards enabling the second users to add the video segments in response to the first segment of the video from the first user and share that back with the first user or other second users.

Another objective of the present disclosure is directed towards enabling the second users to access a collab feature and record one or more video segments without an invitation from the first user.

According to an exemplary aspect of the present disclosure, the system comprising computing devices configured to establish communication with a server over a network, the computing devices comprises a memory configured to store multimedia objects captured using a camera.

According to another exemplary aspect of the present disclosure, the one or more computing devices comprises a video creating module configured to enable a first user to create and record one or more video segments; wherein the video creating module configured to enable the first user to insert placeholders for second users to record their video segments, the video creating module configured to enable the second users to record the one or more video segments on the video.

According to another exemplary aspect of the present disclosure, the server comprises a video collaboration module configured to generate a final video output automatically by combining all the video segments recorded by the second users, wherein the video collaboration module configured to distribute a final video output to the first user and the second users.

According to another exemplary aspect of the present disclosure, enabling the first user to create one or more video segments by a video creating module enabled in a computing device.

According to another exemplary aspect of the present disclosure, allowing the first user to insert placeholders on the video segments for the second users to record their video segments by the video creating module.

According to another exemplary aspect of the present disclosure, inviting the second users to join in the video by the first user using the video creating module.

According to another exemplary aspect of the present disclosure, allowing the second users to record their video segments on the video by using the placeholders.

According to another exemplary aspect of the present disclosure, generating a final video output automatically by combining all the video segments recorded by the second users by a video collaboration module enabled in a server.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system and method to create collaborative videos, in accordance with one or more exemplary embodiments.

FIG. 2 is a block diagram depicting an embodiment of the video creating module 114 on the computing devices and the video collaboration module 116 on the server of shown in FIG. 1, in accordance with one or more exemplary embodiments.

FIG. 3 is a flow diagram depicting a method to create collaborative videos, in accordance with one or more exemplary embodiments.

FIG. 4 is a flow diagram depicting a method to choose a collab feature and recording video segments on a first computing device, in accordance with one or more exemplary embodiments.

FIG. 5 is a flow diagram depicting a method to access a collaboration page and recorded video segments on a second computing device, in accordance with one or more exemplary embodiments.

FIG. 6 is a flow diagram depicting a method for automatically combining video segments, in accordance with one or more exemplary embodiments.

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

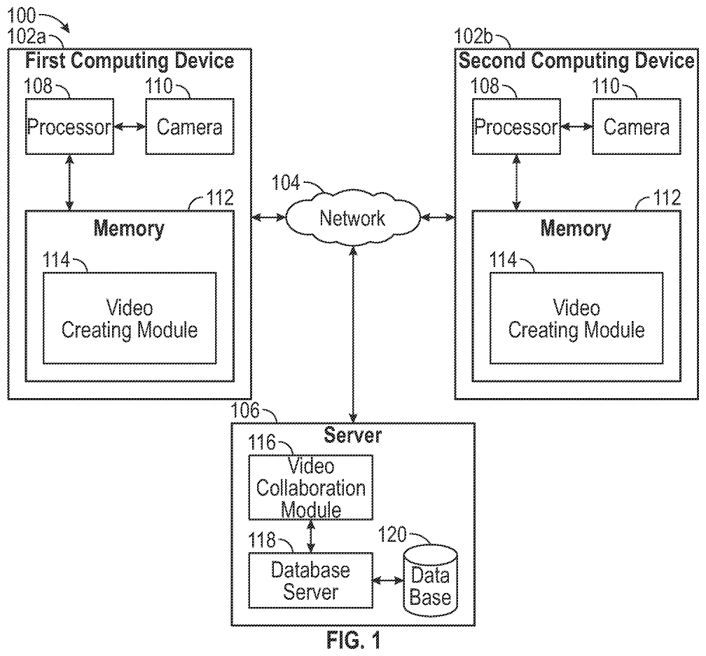

Referring to FIG. 1 is a block diagram 100 depicting a schematic representation of a system and method to create collaborative videos, in accordance with one or more exemplary embodiments. The system 100 includes a first computing device 102a, a second computing device 102b, a network 104, a server 106, a processor 108, a camera 110, a memory 112, a video creating module 114, a video collaboration module 116, a database server 118, and a database 120.

The first computing device 102a may include a first user device. The second computing device 102b may include second users device. The first user may include but not limited to an individual, a client, an operator, an initiator, a creator, and the like. The second users may include but not limited to a responder, collaborators, recipients, and the like. The computing devices 102a, 102b may include, but are not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102a, 102b may include the processor 108 in communication with a memory 112. The processor 108 may be a central processing unit. The memory 112 is a combination of flash memory and random-access memory.

The computing devices 102a, 102b may communicatively connect with the server 106 over the network 104. The network 104 may include, but not limited to, an Internet of things (IoT network devices), an Ethernet, a wireless local area network (WLAN), or a wide area network (WAN), a Bluetooth low energy network, a ZigBee network, a WWI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 106 may be configured to provide access to different types of users.

Although the first computing device 102a or second computing device 102b is shown in FIG. 1, an embodiment of the system 100 may support any number of computing devices. The first computing device 102a or second computing device 102b may be operated by the first user, and the second users. The first computing device 102a or second computing device 102b supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing devices 102a, 102b, includes the camera 110 may be configured to enable the first user and second users to capture the multimedia objects using the processor 108. The computing devices 102a, 102b may include the video creating module 114 in the memory 112. The video creating module 114 may be configured to create collaborative videos on computing devices. The multimedia objects may include, but not limited to videos, short videos, looping videos, animated videos, and the like. The video creating module 114 may be any suitable applications downloaded from GOOGLE PLAY® (for Google Android devices), Apple Inc.'s APP STORE® (for Apple devices), or any other suitable database. The video creating module 114 may be desktop application which runs on Windows or Linux or any other operating system and may be downloaded from a webpage or a CD/USB stick etc. In some embodiments, the video creating module 114 may be software, firmware, or hardware that is integrated into the computing devices 102a, 102b. The computing devices 102a, 102b may present a web page to the user by way of a browser, wherein the webpage comprises a hyper-link may direct the user to uniform resource locator (URL).

The server 106 may include the video collaboration module 116, the database server 118, and the database 120. The video collaboration module 116 may be configured to collaborate one or more videos. The video collaboration module 116 may also be configured to provide server-side functionality via the network 104 to the first user and the second users. The database server 118 may be configured to access one or more databases. The database 120 may be configured to store the first user and the second users recorded videos and interactions between the modules of the video creating module 114, and the video collaboration module 116.

In accordance with one or more exemplary embodiments of the present disclosure, the video creating module 114 may be configured to enable the first user and the second users to post the recorded video segments. The video creating module 114 may be configured to enable the second users to record the one or more video segments using the placeholders. The video creating module 114 may be configured to enable the second users to access the first user recorded videos.

In accordance with one or more exemplary embodiments of the present disclosure, the video creating module 114 may be configured to enable the first user to ask questions to the second users by using the video segment as a video prompt.

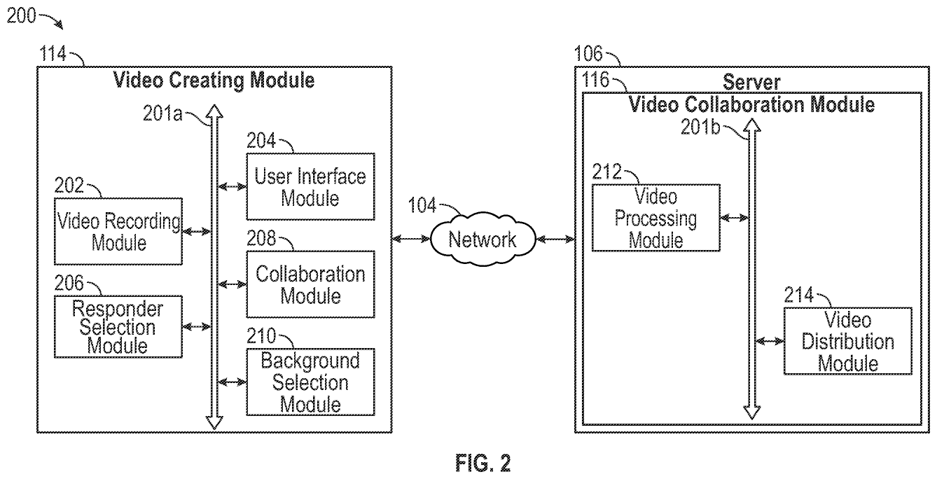

Referring to FIG. 2 is a block diagram 200 depicting an embodiment of the video creating module 114 on the computing devices and the video collaboration module 116 on the server of shown in FIG. 1, in accordance with one or more exemplary embodiments. The video creating module 114 includes a bus 201a, a video recording module 202, a user interface module 204, a responder selection module 206, a collaboration module 208, and a background selection module 210. The bus 201a may include a path that permits communication among the modules of the video creating module 114 installed on the computing devices 102a, 102b. The term “module” is used broadly herein and refers generally to a program resident in the memory 112 of the computing devices 102a, 102b.

The video recording module 202 may be configured to enable the first user to create the one or more segments of the video. The video recording module 202 may be configured to enable the first user and the second users to record the one or more video segments. The video recording module 202 may be configured to enable the first user and the second users to post the recorded video segments on the video creating module 114. The video recording module 202 may be configured to enable the second users to record the one or more video segments using the placeholders. The video recording module 202 may be configured to enable the first user and the second users to record the one or more video segments remotely. The user interface module 204 may be configured to enable the second users to access the first user recorded videos. The recorded videos may include the one or more segments of the video.

The responder selection module 206 may be configured to enable the first user to choose the second users for collaboration. The responder selection module 206 may be configured to enable the first user to invite the second users to join in the video. The collaboration module 208 may be configured to enable the first user and the second users to choose a collab feature for making collaborative videos. The collab feature may provide a script that involves the second users or roles. The roles may be assigned to the second users who choose to collaborate on the video together. In this case, the video creating module 114 may allow each segment to be recorded by the corresponding second users independently. The collab video may include the one or more video segments may be of varying lengths. The collab video may allow the second users in the same video. The collaboration module 208 may be configured to enable the first user to insert the placeholders on the video segments for the second users to record their video segments on the video. The collaboration module 208 may be configured to insert placeholders automatically based on cues in the first user recording. The cues may be recording pauses or auto-detection of pauses in the first user video. The collaboration module 208 may be configured to enable the second users to access a collaboration page. The collaboration module 208 may be configured to enable the second users to check pending invitations or collabs. The collaboration module 208 may be configured to enable the first user and second users to create scripted videos. The background selection module 210 may be configured to enable the second users to access the graphical elements while recording one or more video segments. The background selection module 210 may be configured to enable the second users the creation of seamless experiences that bring a perception of the entire video having been recorded together.

In accordance with one or more exemplary embodiments of the present disclosure, the collaboration module 208 may be configured to enable the second users to access the collab feature and record the one or more video segments without the invitation from the first user.

In accordance with one or more exemplary embodiments of the present disclosure, the video collaboration module 116 includes a bus 201b, a video processing module 212, and a video distribution module 214. The bus 201b may include a path that permits communication among the modules of the video collaboration module 116 installed on the sever 106.

In accordance with one or more exemplary embodiments of the present disclosure, the video processing module 212 may be configured to receive the two or more video segments as the input from the video creating module 114. The video processing module 212 may be configured to process the two or more video segments and generates the final output video.

In accordance with one or more exemplary embodiments of the present disclosure, the video distribution module 214 may be configured to distribute the final output video to the first user and the second users.

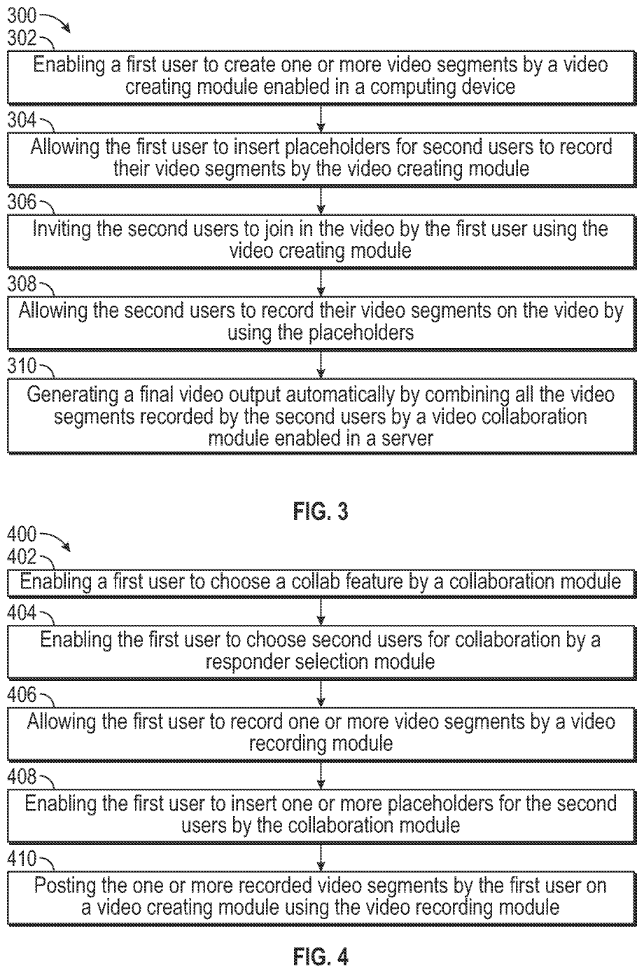

Referring to FIG. 3 is a flow diagram 300 depicting a method to create collaborative videos, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, enabling the first user to create one or more video segments by the video creating module enabled in the computing device. Thereafter at step 304, allowing the first user to insert placeholders for the second users to record their video segments by the video creating module. Thereafter at step 306, inviting the second users to join in the video by the first user using the video creating module. Thereafter at step 308, allowing the second users to record their video segments on the video by using the placeholders. Thereafter at step 310, generating the final video output automatically by combining all the video segments recorded by the second users by the video collaboration module enabled in the server.

Referring to FIG. 4 is a flow diagram 400 depicting a method to choose a collab feature and recording video segments on a first computing device, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the first user to choose a collab feature by the collaboration module. Thereafter at step 404, enabling the first user to choose second users for collaboration by the responder selection module. Thereafter at step 406, allowing the first user to record one or more video segments by the video recording module. Thereafter at step 408, enabling the first user to insert the one or more placeholders for the second users by the collaboration module. Thereafter at step 410, posting the one or more recorded video segments by the first user on the video creating module using the video recording module.

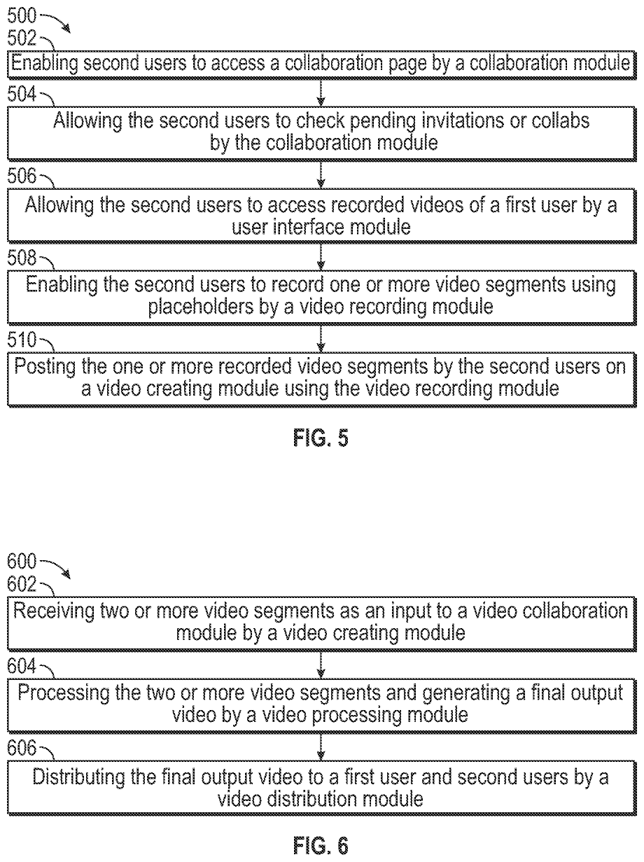

Referring to FIG. 5 is a flow diagram 500 depicting a method to access a collaboration page and recorded video segments on a second computing device, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, enabling the second users to access the collaboration page by the collaboration module. Thereafter at step 504, allowing the second users to check pending invitations or collabs by the collaboration module. Thereafter at step 506, allowing the second users to access the recorded videos of the first user by the user interface module. Thereafter at step 508, enabling the second users to record the one or more video segments using placeholders by the video recording module. Thereafter at step 510, posting the one or more recorded video segments by the second users on the video creating module using the video recording module.

Referring to FIG. 6 is a flow diagram 600 depicting a method for automatically combining video segments, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, receiving two or more video segments as the input to the video collaboration module by the video creating module. Thereafter at step 604, processing the two or more video segments and generating the final output video by the video processing module. Thereafter at step 606, distributing the final output video to the first user and the second users by the video distribution module.

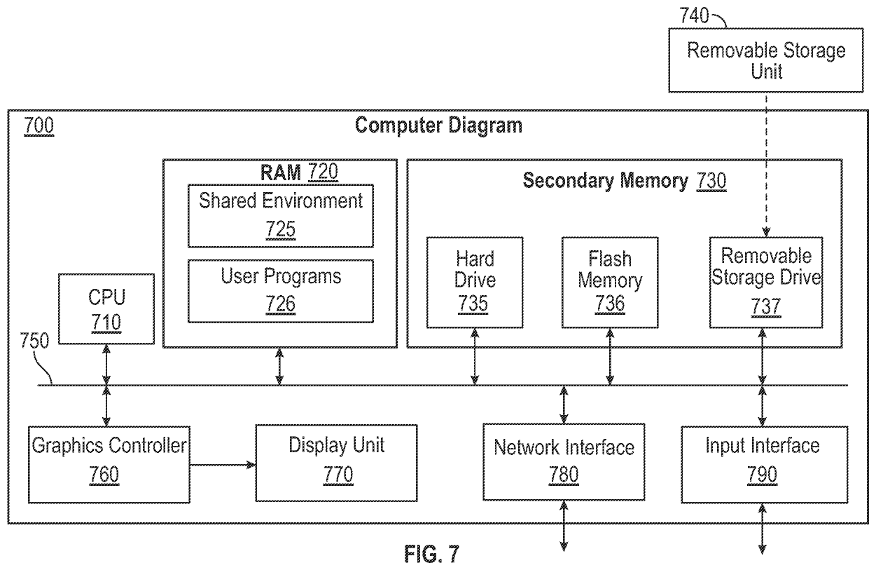

Referring to FIG. 7 is a block diagram 700 illustrating the details of a digital processing system 700 in which various aspects of the present disclosure are operative by execution of appropriate software instructions. The Digital processing system 700 may correspond to the first computing devices 102a, 102b (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1) connected to the network 104.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 750. Transmission media can also take the form of acoustic or light waves, such as those generated during radio-wave and infra-red data communications.

According to an exemplary aspect of the present disclosure, the system comprising computing devices 102a, 102b configured to establish communication with a server 106 over a network 104, the computing devices 102a, 102b comprises a memory 112 configured to store multimedia objects captured using a camera 110.

According to another exemplary aspect of the present disclosure, the one or more computing devices comprises a video creating module configured 114 to enable a first user to create and record one or more video segments; wherein the video creating module 114 configured to enable the first user to insert placeholders for second users to record their video segments, the video creating module 114 configured to enable the second users to record the one or more video segments on the video.

According to another exemplary aspect of the present disclosure, the server 106 comprises a video collaboration module 116 configured to generate a final video output automatically by combining all the video segments recorded by the second users, wherein the video collaboration module 116 configured to distribute a final video output to the first user and the second users.

According to another exemplary aspect of the present disclosure, enabling a first user to create one or more video segments by a video creating module 114 enabled in a computing device.

According to another exemplary aspect of the present disclosure, allowing the first user to insert placeholders on the video segments for the second users to record their video segments by the video creating module 114.

According to another exemplary aspect of the present disclosure, inviting the second users to join in the video by the first user using the video creating module 114.

According to another exemplary aspect of the present disclosure, allowing the second users to record their video segments on the video by using the placeholders.

According to another exemplary aspect of the present disclosure, generating a final video output automatically by combining all the video segments recorded by the second users by a video collaboration module 116 enabled in a server 106.

According to another exemplary aspect of the present disclosure, enabling the second users to access the collab feature and record one or more video segments without an invitation from the first user.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for creating collaborative videos, comprising:
enabling a first user to create one or more video segments by a video creating module enabled in a computing device;
allowing the first user to insert placeholders for second users to record their video segments by the video creating module;
inviting the second users to join in the video by the first user using the video creating module;
allowing the second users to record their video segments on the video by using the placeholders; and
generating a final video output automatically by combining all the video segments recorded by the second users by a video collaboration module enabled in a server.

2. The method of claim 1, comprising a step of enabling the first user to choose a collab feature for making and recording collaborative videos by a collaboration module.

3. The method of claim 1, comprising a step of enabling the first user to choose the second users for collaboration by a responder selection module.

4. The method of claim 1, comprising a step of enabling the first user to invite the second users to join in the video by the responder selection module.

5. The method of claim 1, comprising a step of automatically inserting placeholders based on cues in the first user recording by the collaboration module.

6. The method of claim 1, comprising a step of enabling the first user to create and record the one or more video segments by a video recording module.

7. The method of claim 6, comprising a step of enabling the first user to post the one or more recorded video segments on the video creating module by the video recording module.

8. The method of claim 1, comprising a step of enabling the second users to access a collaboration page by the collaboration module.

9. The method of claim 8, comprising a step of allowing the second users to check pending invitations or collabs by the collaboration module.

10. The method of claim 1, comprising a step of allowing the second users to record the one or more video segments using the placeholders by the video recording module.

11. The method of claim 1, comprising a step of allowing the second users to post the one or more recorded video segments on the video creating module by the video recording module.

12. The method of claim 1, comprising a step of receiving the two or more video segments as the input to a video processing module by the video creating module.

13. The method of claim 12, comprising a step of processing the two or more video segments and generating a final output video by the video processing module.

14. The method of claim 13, comprising a step of distributing the final output video to the first user and the second users by a video distribution module.

15. The method of claim 1, comprising a step of allowing the second users to access graphical elements while recording the one or more video segments by a background selection module.

16. The method of claim 1, comprising a step of allowing the first user and the second users to create scripted videos by the collaboration module.

17. The method of claim 1, comprising a step of enabling the second users to access the first user recorded videos by a user interface module.

18. The method of claim 1, comprising a step of enabling the second users to access the collab feature and record the one or more video segments without the invitation from the first user.

19. A system for creating collaborative videos, comprising:
one or more computing devices configured to establish communication with a server over a network, whereby the one or more computing device comprises a memory configured to store multimedia objects captured using a camera;
the one or more computing devices comprises a video creating module configured to enable a first user to create and record one or more video segments; wherein the video creating module configured to enable the first user to insert placeholders for second users to record their video segments, the video creating module configured to enable the second users to record the one or more video segments on the video; and
the server comprises a video collaboration module configured to generate a final video output automatically by combining all the video segments recorded by the second users, wherein the video collaboration module configured to distribute the final video output to the first user and the second users.

20. A computer program product comprising a non-transitory computer-readable medium having a computer-readable program code embodied therein to be executed by one or more processors, said program code including instructions to:
enable a first user to create one or more video segments by a video creating module enabled in a computing device;
allow the first user to insert placeholders for second users to record their video segments by the video creating module;
invite the second users to join in the video by the first user using the video creating module;
allow the second users to record their video segments on the video by using the placeholders; and
generate a final video output automatically by combining all the video segments recorded by the second users by a video collaboration module enabled in a server.
